(19) United States
(12) Patent Application Publication
(10) Pub. No.: US 2012/0064772 A1
(43) Pub. Date: Mar. 15, 2012

(54) MODULAR CABLE WITH INTEGRAL RECHARGEABLE POWER SUPPLY

(76) Inventor: Alan L. Pocrass, Simi Valley, CA (US)

(21) Appl. No.: 13/321,247

(22) PCT Filed: Mar. 5, 2010
(86) PCT No.: PCT/US2010/026306

§ 371 Date: Nov. 18, 2011

Related U.S. Application Data
(60) Provisional application No. 61/217,694, filed on Jun. 2, 2009.

(51) Int. Cl. H01R 13/40

(52) U.S. Cl. 439/625

(57) ABSTRACT

A modular cable assembly includes first and second flexible cables coupled to a housing and first and second connectors coupled to the respective first and second cables remote from the housing. A rechargeable DC power supply in the housing is operative for storing electrical power received from an external source of DC electrical power via the first connector and for supplying the stored electrical power to an external power consumption device via the second connector. The modular cable assembly can also include a third cable having third and fourth spaced connectors. The second and third connectors are mating connectors that when mated enable the stored electrical power to be supplied to the external power consumption device via the combination of the second, third, and fourth connectors.

### CROSS REFERENCE TO RELATED APPLICATIONS

This application claims priority from U.S. Provisional Application No. 61/217,694, filed Jun. 2, 2009, which is incorporated herein by reference.

### BACKGROUND OF THE INVENTION

1. Field of the Invention

The present invention relates to a modular cable assembly including a rechargeable DC electrical power supply that can be utilized with portable electronic devices having different charging connector arrangements.

2. Description of Related Art

Heretofore, battery backup units for portable electronic devices included rechargeable power supplies, such as rechargeable batteries, supported inside of a housing that included a single connector for connecting to the portable electronic device as an external source of electrical power. These prior art rechargeable power supplies were recharged by mating their connector with a mating connector of a power supply cord that was plugged into a suitable source of electrical power, e.g., either a wall outlet, or a DC power supply output of a device, such as a personal computer.

Problems with such prior art external DC power supplies include: the need to charge the external DC power supply after each use thereof; the need to charge the prior art external DC power supply independently of charging the internal DC power supply of the portable electronic device; and the inability to use the external DC power supply with devices having different mating connector arrangements.

It would, therefore, be desirable to overcome the above problems and others by providing a modular cable assembly with integral DC electrical power supply and interchangeable connectors to enable the modular cable assembly to be utilized with a variety of different connectors of portable electronic devices, such as, without limitation, cell phones, SmartPhones, MP-3 players, wireless headsets, global positioning systems, small computer devices, PDAs, media players, flash drives, gamepads, computer mice, keyboards, scanners, digital cameras, printers, portable printers, hard disks, networking components of personal computers and the like.

### SUMMARY OF THE INVENTION

The invention is a modular USB cable assembly with integral DC electrical power supply. The modular cable assembly includes a housing and a rechargeable DC electric storage device in the housing. A first connector is coupled to the housing via a first flexible cable (comprising wires and a sheath) that extends from the housing and which permits relative movement between the first connector and the housing. In response to the first connector being coupled to a mating connector of an external source of DC electrical power, the first cable can convey DC electrical power from the external source of DC electrical power to the housing. Desirably, the first connector is a type-A USB connector.

A second connector is coupled to the housing via a second flexible cable (also comprising wires and a sheath) that extends from the housing and which permits relative movement between the second connector and the housing. Lastly, a third cable is provided that includes third and fourth spaced connectors and with the second and third connectors being mating connectors. In response to the second and third connectors being mated and the fourth connector being coupled to a mating connector of an external power consumption device, the second and third cables convey DC electrical power from the housing to the external power consumption device.

The DC electrical power conveyed to the housing can be stored in the rechargeable DC electric storage device, used by the external power consumption device in response to the second and third connectors being mated and the fourth connector being coupled to the mating connector of the external power consumption device, or both.

The DC electrical power conveyed from the housing can be conveyed from the rechargeable DC electric storage device, the external source of DC electrical power when the first connector is coupled to the mating connector of the external source of DC electrical power, or both.

In response to the first connector not being coupled to the external source of DC electrical power, the second and third connectors being mated, and the fourth connector being mated to the mating connector of the external power consumption device, DC electrical power can be conveyed to the external power consumption device from the rechargeable DC electric storage device.

In response to the fourth connector not being mated to the external power consumption device, the second and third connectors not being mated, or both, DC electrical power conveyed to the housing (via the first connector coupled to the mating connector of the external source of DC electrical power) can be stored in the rechargeable DC electric storage device.

The modular cable assembly can further include a circuit for controlling charging of the rechargeable DC electric storage device from the DC electrical power conveyed to the housing.

The modular cable assembly can further include a circuit for regulating the DC electrical power conveyed to the external power consumption device from the rechargeable electric storage device, the external source of DC electrical power, or both.

The modular cable assembly can further include a control means operative for connecting the modular cable assembly among at least two of the following states (or modes) in response to user selection when the second and third connectors are mated and the external power consumption device is coupled to the fourth connector: (1) a first state where DC electrical power is conveyed via the first connector coupled to the mating connector of the external source of DC electrical power directly to the external power consumption device bypassing the rechargeable DC electric storage device; (2) a second state where DC electrical power is conveyed via the first connector coupled to the mating connector of the external source of DC electrical power to the rechargeable DC electric storage device and no DC electrical power is conveyed to the external power consumption device; and (3) a third state where DC electrical power is conveyed via the first connector coupled to the mating connector of the external source of DC electrical power to both the rechargeable DC electric storage device and the external power consumption device.

The fourth connector can be a male connector of the following type: a mini-USB type-B connector, a micro-USB type-B connector, or an Apple iPod®-iPhone® connector.

Each cable and each connector includes conductors for conveying DC electrical power, electrical ground, and data. The modular cable assembly can further include a non-volatile memory, a memory card reader, or both and a controller coupled to at least one conductor that conveys data and operating under the control of a control program for transferring data between at least two of the following: the conductor that conveys data, the non-volatile memory, and a memory card coupled in operative relation with the memory card reader.

The controller can further include a user interface coupled to the controller and operative under the control of the control program for enabling user control of the transfer of data.

The modular cable assembly can further include means for converting wireless energy into DC electrical power for either storage in the rechargeable DC electric storage device; use by the external power consumption device in response to the second and third connectors being mated and the fourth connector being coupled to the mating connector of the external power consumption device; or both.

The invention is also a modular USB cable assembly with integral DC electrical power supply. The modular cable assembly includes a rechargeable DC electric storage device supported by a support structure, first and second flexible cables coupled to the support structure, and first and second connectors coupled to the respective first and second cables remote from the support structure. Desirably, the first connector is a type-A USB connector. The modular cable assembly also includes a third flexible cable having third and fourth spaced connectors. The second and third connectors are mating connectors. The modular cable assembly also includes a charging control circuit that is supported by the support structure for controlling charging of the rechargeable DC electric storage device in response to the first connector being coupled with a mating connector of an external source of DC electrical power. Lastly, the modular cable assembly includes a regulating circuit supported by the support structure for regulating DC electrical power conveyed to an external power consumption device from the rechargeable electric storage device, the external source of DC electrical power, or both in response to the second and third connectors being mated and the fourth connector being coupled with a mating connector of the external power consumption device.

The modular cable assembly can further include a switch operative for causing the charging of the rechargeable DC electric storage device from the external source of DC electrical power to be selectively enabled and disabled.

The rechargeable DC electric storage device can comprise one of the following: a rechargeable battery, or a capacitor. The support structure can comprise a housing.

The cables and the connectors comprise conductors for conveying the following: DC electrical power, electrical ground, and data. The modular cable assembly can further include a non-volatile memory, a memory card reader, or both and a controller coupled to at least one conductor that conveys data and operating under the control of a control program for transferring data between at least two of the following: the conductor that conveys data, the non-volatile memory, and a memory card coupled in operative relation with the memory card reader.

The controller can further comprise a user interface coupled to the controller and operative under the control of the control program for enabling user control of the transfer of data.

The modular cable assembly can further include means for converting wireless energy into DC electrical power for either storage in the rechargeable DC electric storage device; use by the external power consumption device in response to the second and third connectors being mated and the fourth connector being coupled to the mating connector of the external power consumption device; or both.

Lastly, the invention is a modular USB cable assembly with integral DC electrical power supply. The modular cable assembly includes first and second flexible cables coupled to a support structure, first and second connectors coupled to the respective first and second cables remote from the support structure, and means for converting wireless energy into DC electrical power. A rechargeable DC electrical power supply is supported by the support structure and is operative for storing electrical power received from the means for converting wireless energy into DC electrical power, an external source of DC electrical power via the first connector or both, and for supplying the stored electrical power to an external power consumption device via the second connector.

The modular cable assembly can further include a third cable having third and fourth spaced connectors. The second and third connectors can be mating connectors that when mated enable the stored electrical power to be supplied to the external power consumption device via the combination of the second, third, and fourth connectors.

The rechargeable DC electrical power supply can include a charge control circuit for controlling the storage of electrical power in the rechargeable DC electrical power supply, and a regulating circuit supported by the support structure for regulating the supply of the stored electrical power to the external power consumption device.

The cables and the connectors include conductors for conveying data between the first and second connectors via the support structure.

### BRIEF DESCRIPTION OF THE DRAWINGS

FIG. 1 is a perspective view of a modular cable assembly in accordance with the present invention;

FIG. 2 is a schematic diagram showing possible internal components of the modular cable assembly of FIG. 1;

FIG. 3 are different embodiment third cables of the modular cable assembly of FIG. 1, each of which includes a different type connector on one end thereof;

FIG. 4a is end views of type-A and type-B USB, mini-USB, and micro-USB connectors that can be utilized with various ones of the third cables shown in FIG. 3;

FIG. 4b is a pin-out of the mini-USB and micro-USB connectors shown in FIG. 4a;

FIGS. 5a and 5b show the pin-out arrangement of the Apple iPod®-iPhone® connector shown in FIG. 3; and

FIG. 6 is a diagrammatic view of an extension/retraction means utilized for extending the cables from the support structure and/or retracting the cables into the support structure shown in FIG. 1.

### DETAILED DESCRIPTION OF THE INVENTION

The present invention will be described with reference to the accompanying figures where like reference numbers correspond to like elements.

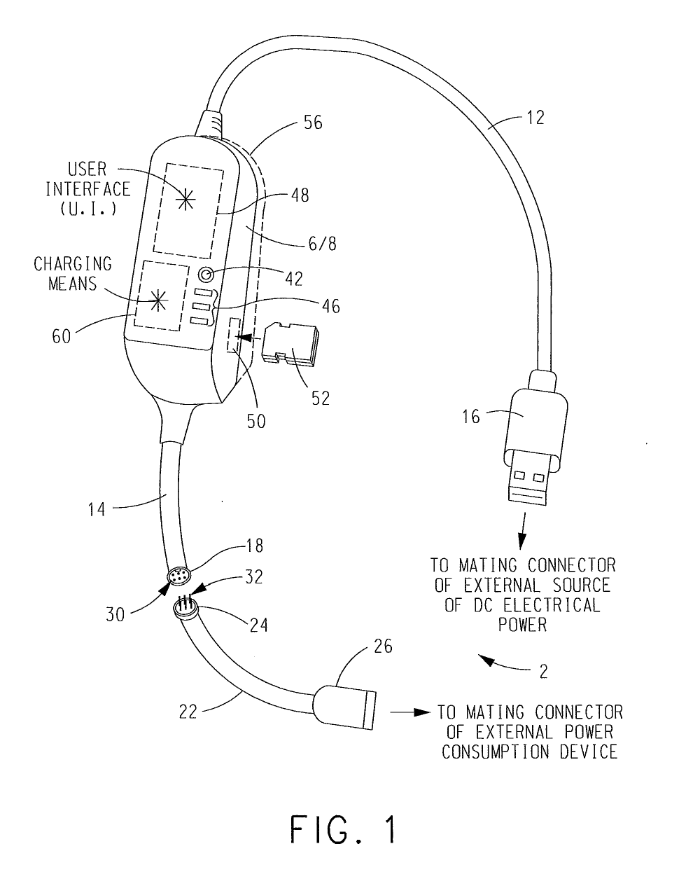

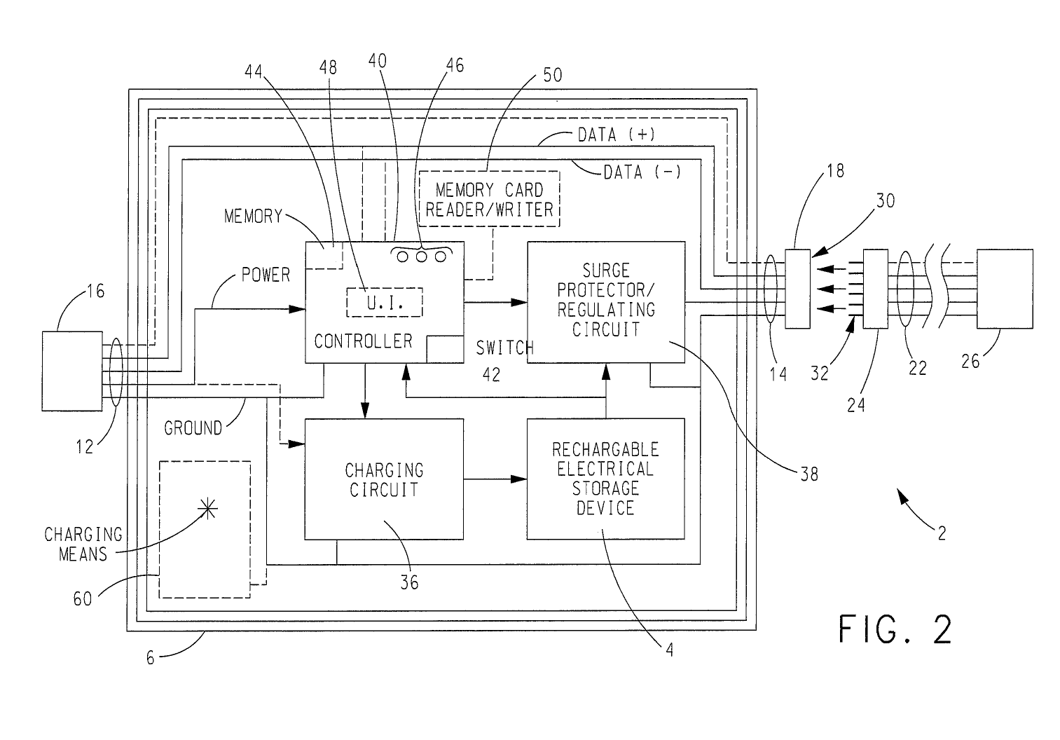

With reference to FIGS. 1 and 2, a modular cable assembly 2 in accordance with the present invention includes a rechargeable DC electric storage device 4 supported by a support structure 6. The support structure 6 can comprise a housing 8 that partially or fully encloses rechargeable DC electric storage device 4. However, the description of support structure 6 comprising housing 8 is not to be construed as limiting the invention since it is envisioned that rechargeable DC electric storage device 4 can be supported in operative relation with the remaining elements (described hereinafter) of modular cable assembly 2 in any suitable and/or desirable manner. For example, without limitation, the support structure can take the form of a vinyl coating of a cable that supports rechargeable DC electric storage device 4 in operative relation to said cable.

Modular cable assembly 2 further includes a first flexible cable 12 coupled to support structure 6 and a second flexible cable 14 also coupled to support structure 6. A first connector 16 is coupled to support structure 6 via first flexible cable 12 that extends from support structure 6 which permits relative movement between first connector 16 and support structure 6. A second connector 18 is coupled to support structure 6 via second flexible cable 14 that extends from support structure 6 and which permits relative movement between second connector 18 and support structure 6. Desirably, first connector 16 is a type-A USB connector.

First flexible cable 12 and first connector 16 include conductors that are coupled in operative relation to rechargeable DC electric storage device 4 whereupon in response to first connector 16 being coupled to a mating connector (not shown) of an external source of DC electric power (also not shown), first cable 12 conveys DC electric power from the external source of DC electric power to support structure 6 and, more particularly, to rechargeable DC electric storage device 4.

Modular cable assembly 2 can further include a third flexible cable 22 including a third connector 24 and a fourth connector 26 held in spaced relation by third cable 22. Second connector 18 and third connector 24 are mating connectors. In the embodiment shown in FIGS. 1 and 2, second connector 18 has a pattern of female receptacles 30 and third connector 24 has a mating pattern of male pins 32 for insertion into female receptacles 30 when second connector 18 and third connector 24 are mated. However, this is not to be construed as limiting the invention since it is envisioned that second connector 18 can include a pattern of male pins and third connector 24 can include a mating pattern of female receptacles. The use of other arrangements or styles of second connector 18 and third connector 24, such as, without limitation, mating USB connectors, having different styles of mating conductors are also envisioned.

Fourth connector 26 is configured to mate with the mating connector of an external power consumption device (not shown), such as, without limitation, a portable MP-3 player, a cell phone, so-called SmartPhones, and/or any other suitable and/or desirable external power consumption device.

In response to the second and third connectors being mated and the fourth connector being coupled to the mating connector of the external power consumption device, second cable 14 and third cable 22 convey DC electric power from support structure 6 to the external power consumption device.

When first connector 16 is coupled to the mating connector of the external source of DC electric power, the DC electric power conveyed to support structure 6 from the external source of DC electric power can be stored in rechargeable DC electric storage device 4, used by the external power consumption device when the second and third connectors are mated and the fourth connector is coupled to the mating connector of the external power consumption device, or both.

When second connector 18 and third connector 24 are mated and fourth connector 26 is coupled to the mating connector of the external power consumption device, DC electrical power conveyed from the support structure can be conveyed from rechargeable DC electric storage device 4, the external source of DC electric power when first connector 16 is coupled to the mating connector of the external source of DC electric power, or both.

More specifically, in response to first connector 16 not being coupled to the external source of DC electric power, the second and third connectors 18 and 24 being mated, and fourth connector 26 being mated to the mating connector of the external power consumption device, DC electric power is conveyed to the external power consumption device from rechargeable DC electric storage device 4. In response to fourth connector 26 not being mated to the external power consumption device, the second and third connectors 18 and 24 not being mated, or both, DC electric power conveyed to the housing via first connector 16 is stored in rechargeable DC electric storage device 4.

Each cable 12, 14, and 22 and each connector 16, 18, 24, and 26 includes conductors, each of which conveys at least one of the following: DC electric power, electric ground, or data. Each cable 12, 14, and 22 and each connector 16, 18, 24, and 26 can also or alternatively include suitable and/or desirable shielding, and/or additional conductors for other or expansion purposes. Hence, the number of conductors each cable 12, 14, and 22 and each connector 16, 18, 24, and 26 includes is not to be construed as limiting the invention. The female receptacles 30 and male pins 32 of second and third connectors 18 and 24 define the conductors thereof.

In its simplest embodiment, modular cable assembly 2 includes first and second flexible cables 12 and 14 coupled to support structure 6. First and second connectors 16 and 18 are coupled to the respective first and second cables 12 and 14 remote from support structure 6. Rechargeable DC electric storage device 4 is supported by support structure 6 and is operative for storing electrical power received from an external source of DC electric power via first connector 16 and for supplying the stored electrical power to an external power consumption device via second connector 18.

The simplest embodiment of modular cable assembly 2 can further include third cable 22 having third and fourth spaced connectors 24 and 26. Second connector 18 and third connector 24 are mating connectors that when mated enable the electrical power stored in rechargeable DC electric storage device 4 to be supplied to the external power consumption device via the combination of fourth connector 26 and the mated second connector 18 and third connector 24.

Another embodiment of modular cable assembly 2 can include the various elements of the simplest embodiment of the modular cable assembly 2 described above and can further include a charging circuit 36 coupled to receive DC electric power from the external source of DC electric power via one or more conductors of first cable 12. The output of charging circuit 36 is coupled to rechargeable DC electric storage device 4. In operation, charging circuit 36 controls the charging of rechargeable DC electric storage device 4 from DC electric power conveyed to support structure 6 via the one or more conductors of flexible cable 12. Charging circuit 36 operates to charge rechargeable DC electric storage device 4 in a controlled manner and to prevent overcharging thereof.

Also or alternatively, modular cable assembly 2 can include a surge protector/regulating circuit 38 that is coupled to the output of rechargeable DC electric storage device 4, the DC electric power supplied by the one or more conductors of first cable 12, or both. Surge protector/regulating circuit 38 is operative for regulating DC electric power conveyed to the external power consumption device via one or more conductors of second cable 14, second connector 18 mated with third connector 24, third cable 22, and fourth connector 26, from the rechargeable DC electric storage device 4, the external source of DC electric power coupled to first connector 16, or both.

Charging circuit 36 and surge protector/regulating circuit 38 can be used either individually or in combination or not at all depending upon the intended use of modular cable assembly 2. However, it is envisioned that a preferred embodiment of modular cable assembly 2 will include charging circuit 36 and surge protector/regulating circuit 38 coupled and operative in the manner discussed above.

Modular cable assembly 2 may further include a controller 40. In its simplest form, controller 40 comprises a switch 42 that is operative for connecting modular cable assembly in a number of different states in response to user activation of switch 42 when second connector 18 and third connector 24 are mated and the external power consumption device is coupled to fourth connector 26. For example, without limitation, in response to activating switch 42, modular cable assembly 2 can be set to a first state where DC electric power is conveyed via first connector 16 coupled to the mating connector of the external source of DC electrical power directly to the external power consumption device, bypassing rechargeable DC electric storage device 4. Switch 42 may also be activated to connect modular cable assembly 2 in a second state where DC electric power is conveyed via the first connector coupled to the mating connector of the external source of DC electrical power to rechargeable DC electric storage device 4 and no DC electric power is conveyed to the second connector 18 and, hence to the external power consumption device. Lastly, switch 42 may be activated to connect modular cable assembly 2 in a third state where DC electric power is conveyed via the first connector coupled to the mating connector of the external source of DC power to both rechargeable DC electric storage device 4 and the external power consumption device.

Also or alternatively, controller 40 can comprise a microprocessor powered by rechargeable DC electric storage device 4 and operating under the control of a control program stored in a memory 44 such as, without limitation, a flash memory. However, this is not to be construed as limiting the invention. Controller 40 may include one or more LEDs 46. Controller 40 may be connected to rechargeable DC electric storage device 4 and may include suitable internal circuitry for causing LEDs 46 to light in a manner corresponding to the present level of the electrical power stored in rechargeable DC electric storage device 4.

As shown in FIG. 2, controller 40 may also be connected to one or more conductors (shown by dashed lines in FIG. 2) of modular cable assembly that are utilized for conveying data from first connector 16 to fourth connector 26 via second and third connectors 18 and 24 when mated. Controller 40 may be operative for: storing data transferred on said conductors in memory 44; for transferring data stored in memory 44 to first connector 16 or fourth connector 26 via mated second and third connectors 18 and 24; or both.

To facilitate its operation, controller 40 may include a user interface (U.I.) 48. User interface 48 may comprise a display screen and/or a keyboard to facilitate user interaction with controller 40 to store data in memory 44; to transfer data from memory 44 to first connector 16 or fourth connector 26; or to control the state of modular cable assembly 2 in the manner discussed above in connection with switch 42. To this end, user interface 48 can include a touch display that can display one or more virtual buttons under the control of the microprocessor of controller 40 to enable a user to store in memory 44 data conveyed on the one or more conductors of modular cable assembly 2 and/or to enable the user to convey data stored in memory 44 to first connector 16 and/or fourth connector 26 when second connector 18 and third connector 24 are mated. The touch display of user interface 48 may also include a virtual button in replacement of switch 42 for enabling the user of modular cable assembly 2 to connect it in one or more of the states discussed above in connection with switch 42.

Modular cable assembly 2 may also include a memory card reader/writer 50 (shown in phantom) coupled to controller 40. Under the control of controller 40, memory card reader/writer 50 can be utilized for reading and/or writing data from and/or to a memory card 52 disposed in operative relation to memory card reader/writer 50. More specifically, under the control of controller 40, memory card reader/writer 50 can be utilized to write data from memory 44 to memory card 52 or the conductors of modular cable assembly 2 utilized for conveying data. Also or alternatively, under the control of controller 40, memory card reader/writer 50 can transfer data stored on memory card 52 to memory 44 and/or the conductors of modular cable assembly 2 utilized for conveying data.

By way of user interface 48 of controller 40 operating under the control of the control program, data can be transferred between at least two of the following: the one or more conductors of modular cable assembly 2 that convey data, non-volatile memory 44, and/or memory card 52 coupled in operative relation with memory card reader 50.

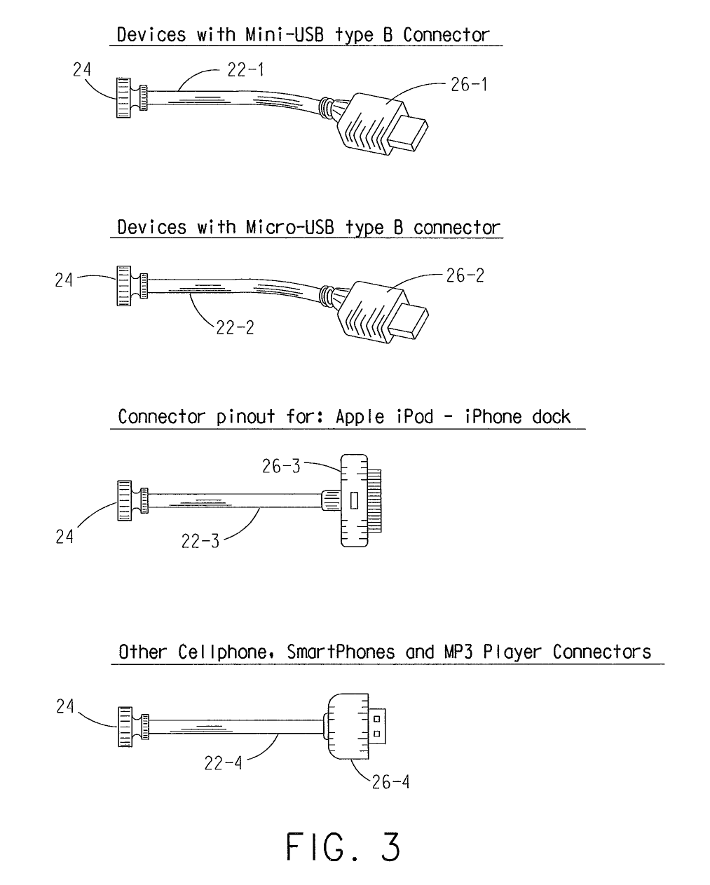

With reference to FIG. 3 and with continuing reference to FIGS. 1 and 2, cable 22 can be of any suitable and/or desirable configuration. One configuration is cable 22-1 which includes a mini-USB type-B connector as fourth connector 26-1. Another embodiment of cable 22-2 includes a micro-USB type-B connector as fourth connector 26-2.

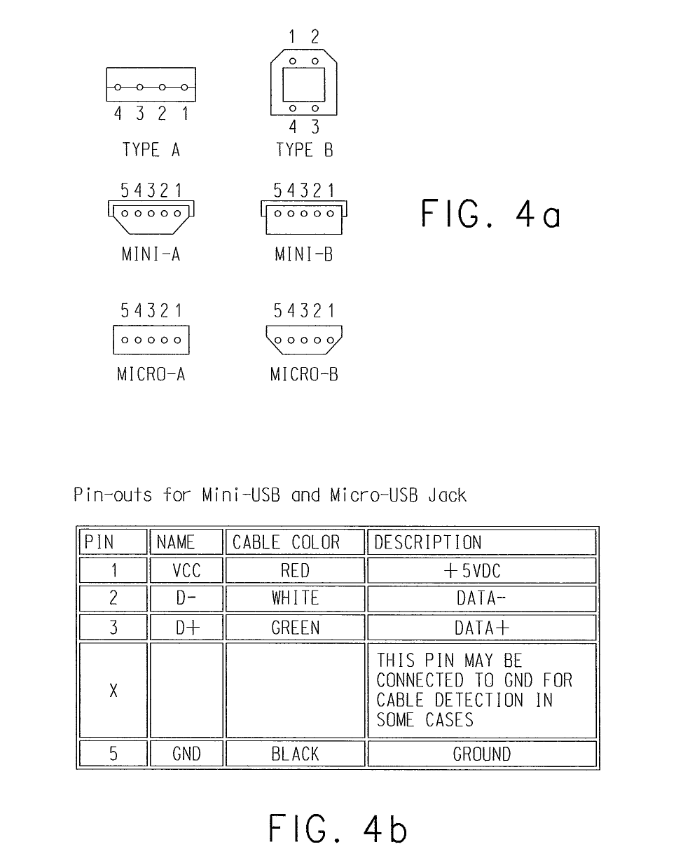

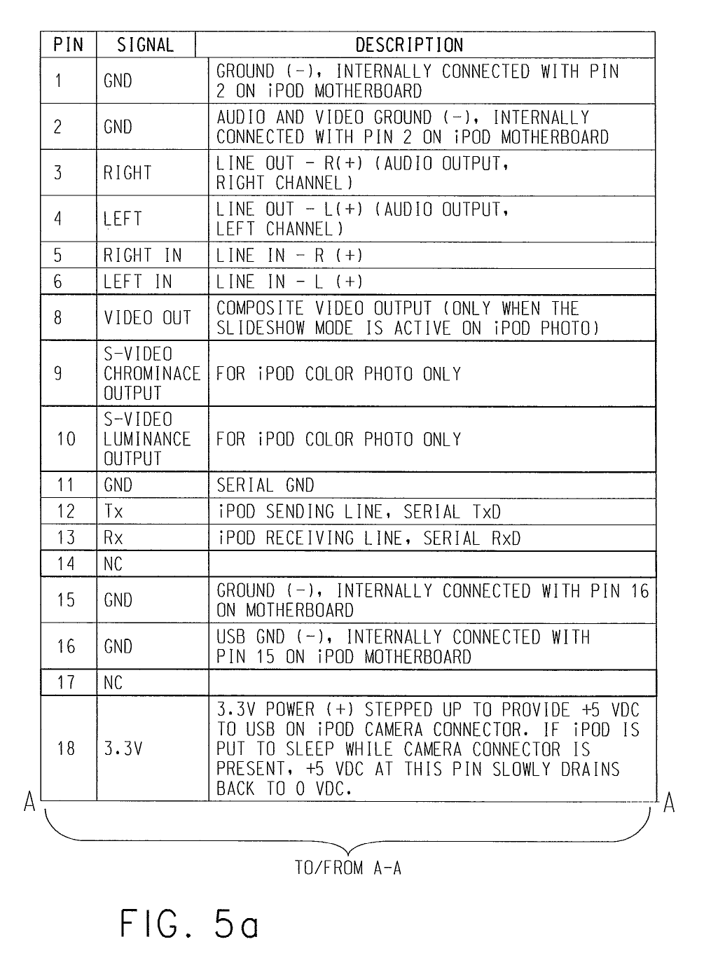

End of views of type-A and type-B USB, mini-USB, and micro-USB type connectors are shown in FIG. 4a. FIG. 4b is a table showing a standard conductor configuration assigned to the pins, and their functions (i.e., the pin-out arrangement) for the mini-USB and micro-USB connectors shown in FIG. 4a. However, this pin-out arrangement is not to be construed as limiting the invention since it is envisioned that a different pin-out arrangement having the same, more, or less conductors, and different types of known and/or to-be-developed USB connectors can also be used.

Referring back to FIG. 3, another embodiment third cable 22-3 includes an Apple iPod®-iPhone® connector as fourth connector 26-3.

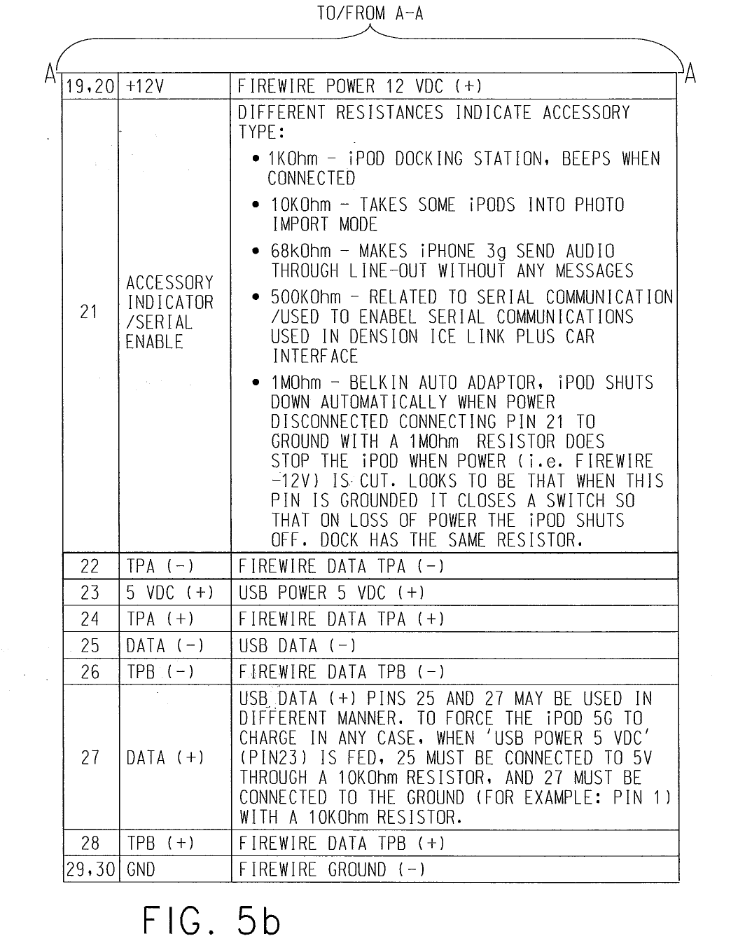

“iPod®” and “iPhone®” are registered trademarks of Apple Inc. FIGS. 5a and 5b are a table showing the cross-reference between the contacts, or pins, (i.e., the pin-out arrangement) of connector 26-3 and their functions.

Lastly, FIG. 3 shows another embodiment third cable 22-4 that includes a connector for connection to cell phones, SmartPhones, and MP-3 players as fourth connector 26-4.

As can be appreciated from the foregoing description, by selection of a suitable third cable 22, the combination of first connector 16, first cable 12, support structure 6, second cable 14, and second connector 18 along with rechargeable DC electric storage device 4 supported by support structure 6, can be utilized for supplying electrical power to an external power consumption device coupled to a suitable mating connector 26. Thus, for example, if the external power consumption device includes a mini-USB type-A connector, third cable 22-1 including mini-USB type-B connector 26-1 would be selected. In this case, third connector 24 of third cable 22-1 in FIG. 3 would be coupled to mating connector 18 of second cable 14. If it was subsequently desired to utilize modular cable assembly 2 with an Apple iPod®-iPhone®, third connector 24 of third cable 22-1 would be disconnected from second connector 18 of second cable 14. Thereafter, connector 24 of third cable 22-3 including an Apple iPod®-iPhone® connector 26-3 would be coupled to second connector 18 of second cable 14. Thus, the combination of first connector 16, first cable 12, rechargeable DC electric storage device 4 support by support structure 6, second cable 14, and second connector 18 can be utilized with a variety of different third cables, each of which may include a different type of fourth connector 26 for supplying DC electric power to external power consumption devices having different types of mating connectors.

Desirably, rechargeable DC electric storage device 4 is replaceable. Thus, when rechargeable DC electric storage device 4 requires replacement, e.g., for failing to hold an electrical charge, it can be removed from modular cable assembly and replaced with a replacement rechargeable DC electric storage device 4.

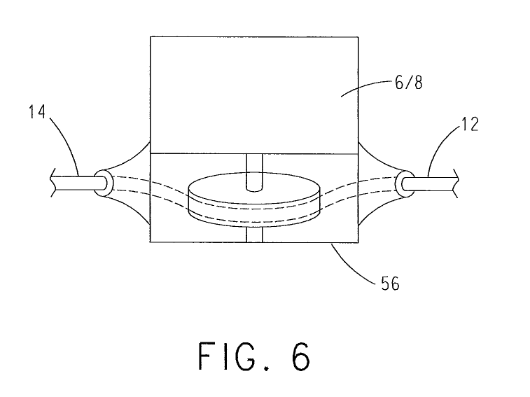

If desired, any of the embodiments of modular cable assembly 2 described herein can include an extension/retraction means 56 (shown in phantom in FIG. 1) that can be operative to enable a user of modular cable assembly 2 to dispense first cable 12 and/or second cable 14 from support structure 6 and/or to withdraw first cable 12 and/or second cable 14 into support structure 6, especially support structure 6 in the form of housing 8. With reference to FIG. 6, retraction means 56 can include a spring loaded spindle 58 coupled to first and second cables 12 and 14 in a manner whereby the conductors of first and second cables 12 and 14 are connected in one or more of the manners described above. Spindle 58 can be spring loaded and lockable whereupon when one or both of cables 12 and 14 are extended to a suitable length from retraction means 56, the length of first cable 12 and/or second cable 14 can be set against the tension of spring mounted spindle 58 so that spindle 58 does not retract first cable 12 and/or second cable 14 back into support structure 6. If desired, however, spring loaded spindle 58 can be activated by a user to withdraw first cable 12 and/or second cable 14 into support structure 6 to a desired extent, including fully retracted whereupon first connector 16 and/or second connector 18 abut and/or are closely adjacent support structure 6. The use of retraction means 56 enables a user of modular cable assembly 2 to retract first cable 12 and second cable 14 into support structure 6 at desirable times, e.g., when modular cable assembly is not in use and/or for transportation purposes, and to withdraw first cable 12 and/or second cable 14 from support structure 6 when modular cable assembly is in use.

Any of the above-described embodiments of modular cable assembly 2 can also or alternatively include a charging means 60 (shown in phantom in FIGS. 1 and 2) that is operative for converting wireless energy into DC electrical power that can be used for charging rechargeable DC electric storage device 4, either directly or via charging circuit 36, if provided.

Charging means 60 can be coupled to modular cable assembly 2 at any suitable and/or desirable location. Accordingly, the illustration of charging means 60 as part of support structure/housing 6/8 in FIGS. 1 and 2 is not to be construed as limiting the invention.

Modular cable assembly 2 can include the combination of first flexible cable /first connector 12/16 and charging means 60 for enabling charging of rechargeable electric storage device from the external source of DC electric power via first connector 16 and first cable 12 in the manner described above, or via charging means 60. Alternatively, modular cable assembly 2 can exclude first flexible cable 12 and first connector 16 in favor of charging means 60 as the sole means for recharging rechargeable electric storage device 4. In other words, modular cable assembly 2 can include first flexible cable 12 and first connector 16 for coupling to the external source of DC electric power for charging rechargeable DC electric storage 4; can include charging means 60 for charging rechargeable DC electric storage device 4, or both.

Charging means 60 can be any suitable and/or desirable device that is capable of converting wireless energy into DC electrical power for charging rechargeable DC electric storage device 4, i.e., converting electrical energy transmitted from a power source to charging means 60 without the use of interconnecting wires.

Non-limiting examples of wireless energy that can be converted into DC electrical power include inductive coupling where the transfer of energy takes place by electromagnetic coupling through a process known as mutual induction (e.g., a transformer), electrodynamic induction, electrostatic induction, electromagnetic waves of any suitable and/or desirable frequency including radio waves, microwaves, infrared waves, visible light, ultraviolet, X-ray, gamma rays, etc., laser light, electroconduction, magnetic resonance, and the like. The foregoing list, however, is not to be construed as limiting the invention since it is envisioned that any suitable and/or desirable charging means 60 that is capable of producing electrical energy for charging rechargeable DC electric storage device 4 by way of wireless energy transfer or wireless power transmission can be utilized.

In one non-limiting embodiment, charging means can be an array of solar cells that convert light energy into electricity, or one or more wires arranged to wirelessly receive power via inductive coupling with a suitable source of magnetic energy (e.g., in the manner that the secondary side of a transformer magnetically couples with the primary side of a transformer).

The present invention has been described with reference to the preferred embodiments. Obvious modifications and alterations will occur to others upon reading and understanding the preceding detailed description. It is envisioned that the invention be construed as including all such modifications and alterations insofar as they come within the scope of the appended claims or the equivalents thereof.

The invention claimed is:

1. A modular cable assembly with integral DC electrical power supply comprising:
a housing;
a rechargeable DC electric storage device in the housing;
a first connector coupled to the housing via a first flexible cable that extends from the housing and which permits relative movement between the first connector and the housing, wherein in response to the first connector being coupled to a mating connector of an external source of DC electrical power, the first cable conveys DC electrical power from the external source of DC electrical power to the housing, wherein the first connector is a type-A USB connector;
a second connector coupled to the housing via a second flexible cable that extends from the housing and which permits relative movement between the second connector and the housing; and
a third cable including third and fourth spaced connectors, wherein the second and third connectors are mating connectors, wherein in response to the second and third connectors being mated and the fourth connector being coupled to a mating connector of an external power consumption device, the second and third cables convey DC electrical power from the housing to the external power consumption device.

2. The modular cable assembly of claim 1, wherein the DC electrical power conveyed to the housing is:
stored in the rechargeable DC electric storage device;
used by the external power consumption device in response to the second and third connectors being mated and the fourth connector being coupled to the mating connector of the external power consumption device; or
both.

3. The modular cable assembly of claim 1, wherein the DC electrical power conveyed from the housing is conveyed from:
the rechargeable DC electric storage device;
the external source of DC electrical power when the first connector is coupled to the mating connector of the external source of DC electrical power; or both.

4. The modular cable assembly of claim 1, wherein in response to the first connector not being coupled to the external source of DC electrical power, the second and third connectors being mated, and the fourth connector being mated to the mating connector of the external power consumption device, DC electrical power is conveyed to the external power consumption device from the rechargeable DC electric storage device.

5. The modular cable assembly of claim 1, wherein in response to the fourth connector not being mated to the external power consumption device, the second and third connectors not being mated, or both, DC electrical power conveyed to the housing is stored in the rechargeable DC electric storage device.

6. The modular cable assembly of claim 1, further including a circuit for controlling charging of the rechargeable DC electric storage device from the DC electrical power conveyed to the housing.

7. The modular cable assembly of claim 1, further including a circuit for regulating the DC electrical power conveyed to the external power consumption device from the rechargeable electric storage device, the external source of DC electrical power, or both.

8. The modular cable assembly of claim 1, further including a controller operative for connecting the modular cable assembly among at least two of the following states in response to an external user input when the second and third connectors are mated and the external power consumption device is coupled to the fourth connector:
a first state where DC electrical power is conveyed via the first connector coupled to the mating connector of the external source of DC electrical power directly to the external power consumption device bypassing the rechargeable DC electric storage device;
a second state where DC electrical power is conveyed via the first connector coupled to the mating connector of the external source of DC electrical power to the rechargeable DC electric storage device and no DC electrical power is conveyed to the external power consumption device; and
a third state where DC electrical power is conveyed via the first connector coupled to the mating connector of the external source of DC electrical power to both the rechargeable DC electric storage device and the external power consumption device.

9. The modular cable assembly of claim 1, wherein the fourth connector is a male connector one of the following type:
a mini-USB type-B connector;
a micro-USB type-B connector; or
an Apple iPod—iPhone connector.

10. The modular cable assembly of claim 1, wherein:
each cable and each connector include conductors, each of which conveys one of the following: DC electrical power, electrical ground, or data; and
the modular cable assembly further includes:
a non-volatile memory, a memory card reader, or both; and
a controller coupled to at least one conductor that conveys data and operating under the control of a control program for transferring data between at least two of the following: the conductor that conveys data, the non-volatile memory, and a memory card coupled in operative relation with the memory card reader.

11. The modular cable assembly of claim 10, wherein the controller further comprises a user interface coupled to the controller and operative under the control of the control program for enabling user control of the transfer of data.

12. The modular cable assembly of claim 1, further including means for converting wireless energy into DC electrical power for either storage in the rechargeable DC electric storage device; use by the external power consumption device in response to the second and third connectors being mated and the fourth connector being coupled to the mating connector of the external power consumption device; or both.

13. A modular cable assembly with integral DC electrical power supply comprising:
a rechargeable DC electric storage device supported by a support structure;
first and second flexible cables coupled to the support structure;
first and second connectors coupled to the respective first and second cables remote from the support structure, the first connector being a type-A USB connector;
a third flexible cable having third and fourth spaced connectors, wherein the second and third connectors are mating connectors;
a charging control circuit supported by the support structure for controlling charging of the rechargeable DC electric storage device in response to the first connector being coupled with a mating connector of an external source of DC electrical power; and
a regulating circuit supported by the support structure for regulating DC electrical power conveyed to an external power consumption device from the rechargeable electric storage device, the external source of DC electrical power, or both in response to the second and third connectors being mated and the fourth connector being coupled with a mating connector of the external power consumption device.

14. The modular cable assembly of claim 13, further including a switch operative for causing the charging of the rechargeable DC electric storage device from the external source of DC electrical power to be selectively enabled and disabled.

15. The modular cable assembly of claim 13, wherein:
the rechargeable DC electric storage device comprises one of the following: a rechargeable battery, or a capacitor; and
the support structure comprises a housing.

16. The modular cable assembly of claim 13, wherein:
the cables and the connectors comprise conductors, each of which conveys one of the following: DC electrical power, electrical ground, or data; and
the modular cable assembly further includes:
a non-volatile memory, a memory card reader, or both; and
a controller coupled to at least one conductor that conveys data and operating under the control of a control program for transferring data between at least two of the following: the conductor that conveys data, the non-volatile memory, and a memory card coupled in operative relation with the memory card reader.

17. The modular cable assembly of claim 16, wherein the controller further comprises a user interface coupled to the controller and operative under the control of the control program for enabling user control of the transfer of data.

18. The modular cable assembly of claim 13, further including means for converting wireless energy into DC electrical power for either storage in the rechargeable DC electric storage device; use by the external power consumption device in response to the second and third connectors being mated and the fourth connector being coupled to the mating connector of the external power consumption device; or both.

19. A modular cable assembly with integral DC electrical power supply comprising:
first and second flexible cables coupled to a support structure;
first and second connectors coupled to the respective first and second cables remote from the support structure;
means for converting wireless energy into DC electrical power ; and
a rechargeable DC electrical power supply supported by the support structure and operative for storing electrical power received from either the means for converting wireless energy into DC electrical power, an external source of DC electrical power via the first connector, or both, and for supplying the stored electrical power to an external power consumption device via the second connector.

20. The modular cable assembly of claim 19, further including a third cable having third and fourth spaced connectors, wherein the second and third connectors are mating connectors that when mated enable the stored electrical power to be supplied to the external power consumption device via the combination of the second, third, and fourth connectors.

21. The modular cable assembly of claim 19, wherein the rechargeable DC electrical power supply includes:
a charge control circuit for controlling the storage of electrical power in the rechargeable DC electrical power supply; and
a regulating circuit supported by the support structure for regulating the supply of the stored electrical power to the external power consumption device.

22. The modular cable assembly of claim 19, wherein the cables and the connectors include conductors for conveying data between the first and second connectors via the support structure.
